(19) United States
(12) Patent Application Publication
(10) Pub. No.: US 2009/0044451 A1
(43) Pub. Date: Feb. 19, 2009

(54) Apparatus for wind protection of building openings

(76) Inventors: Leonard Charles Quick, Mandeville, LA (US); Gaetano Dominick Paternostro, JR., Big Branch, LA (US)

Correspondence Address: KENNETH L. TOLAR, 2908 Hessmer Avenue, Metairie, LA, 70002, US

(21) Appl. No.: 11/077,447

(22) Filed: Mar. 10, 2005

(51) Int. Cl. E06B 5/12; E06B 5/10

(52) U.S. Cl. 49/57

(57) ABSTRACT

A retaining bar for securing position of a protective panel within a recess of a building, Such as a window frame or a door frame. The retaining bar has two telescopically engageable portions, which are tensioned in the frame. Each retaining bar member carries a bracket, which contacts the window or door frame once the bar members are extended to fit tightly within the frame. A threaded rod mounted in one of the bracket assemblies allows tightening of the retaining bar in the frame.

### BACKGROUND OF THE INVENTION

The present invention relates to the protection of windows and doors from strong winds, such as occasioned by hurricane and other natural forces. More particularly, the present invention relates to a device for securing protective panels in window and door frames to help protect glass from flying objects and from wind forces during storms, hurricanes, tornadoes and the like.

Many buildings in certain areas of the country are damaged by violent storms when wind-carried objects are hurled against glass covered windows and doors. The objects flown by wind can cause substantial damage to the structure. It is common in preparation for hurricanes to place plywood or wooden panels on the outside of the structure to help protect the buildings and prevent glass breakage. Conventionally, the protective panels are installed by either screws or nails driven through the panels directly into the window frames. However, driving screws and nails into the aluminum frame window is difficult, often makes unsightly holes in the structure and can cause breakage of the glass due to vibration. Additionally, many manufacturers, while providing warranty to the windows and frames, will not honor the warranty if a screw hole or nail hole is made in the window frame. The created holes create an opportunity for moisture to penetrate into the building or inside the wood structure, which will gradually damage the window frame and may require expensive replacement.

The present invention contemplates elimination of drawbacks associated with conventional methods of installing protective coverings for a building opening and provision of a device for retaining protective panels in place without the need for penetrating the frame of a window, door, or veneer covering of the building.

### SUMMARY OF THE INVENTION

It is therefore, an object of the present invention to provide an apparatus for retaining a wind protection panel in a frame opening of a door or window of a building.

It is another object of the present invention to provide an apparatus for retaining a protective panel in the building opening structure without using complicated equipment or skilled labor.

These and other objects of the present invention are achieved through a provision of an apparatus for retaining protecting panels placed in a recess of a wall of a building, more specifically within a window frame or a door frame. The apparatus comprises at least one retainer bar, which is tensioned in the frame outside of a protective panel, be it a plywood, panel, plastic panel or metal panel. The retaining bar is formed as a two-part elongated member, where a first portion, or bar member, telescopically receives a second portion, or second bar member.

The first bar member is provided with a row of through openings, through which a locking button extends to lock the longitudinal extension of the second bar member from the first bar member. The locking button, or buttons are secured to a tensioned member, which is positioned inside the second bar member, urging the button outwardly, through the locking opening.

A bracket assembly is mounted on a free end of each of the first bar member and the second bar member. The bracket assembly has a pair of spaced-apart bracket members, which contact the inside of the frame. The bracket members are generally U-shaped, and one of the tabs of the bracket member contacts the panel being secured in the frame. The first bar member freely rotates in relation to the second bar member and in relation to its bracket assembly. The second bracket assembly has a threaded rod, to which the bracket members are connected. Rotating the bracket assembly allows tightening of position of the retaining member within the frame.

### BRIEF DESCRIPTION OF THE DRAWINGS

Reference will now be made to the drawings, wherein like parts are designated by like numerals and wherein

FIG. 1 is a perspective view of the apparatus of the present invention installed in a window frame.

FIG. 2 is a detail view illustrating position of the bracket assembly when installed in a building opening frame.

FIG. 3 is a detail, partially cutaway view, illustrating a fixed end bracket assembly of the apparatus of the present invention.

FIG. 4 is a detail, partially cutaway view, illustrating a means for adjusting the length of the retaining bar of the apparatus of the present invention.

FIG. 5 is a detail, partially cutaway view, illustrating a threaded end of the retainer bar of the present invention.

### DETAILED DESCRIPTION OF THE PREFERRED EMBODIMENT

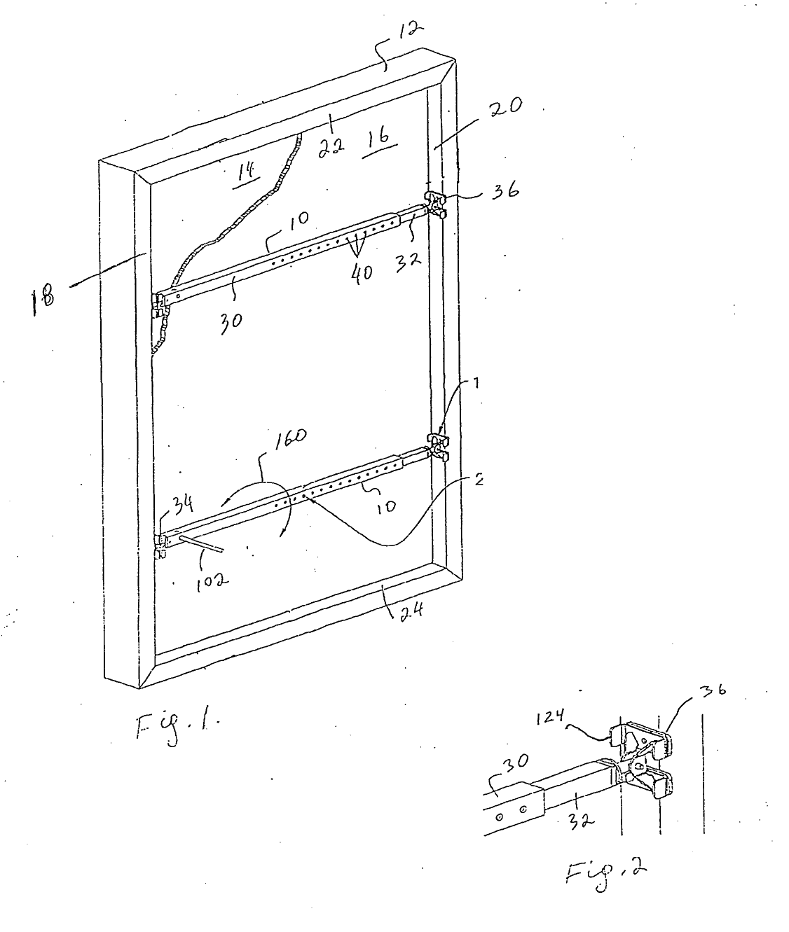

Turning now to the drawings in more detail, numeral 10 designates a retaining bar in accordance with the present invention. As can be seen in FIG. 1, one or more retaining bars 10 may be provided for each building opening, depending on the height of the opening and the size of the protective panel. A window frame or a door frame 12 is provided with a fragile panel 14, for instance a glass panel. In preparation for storm, the user cuts out a protective panel 16 which can be made of plywood, metal, plastic, or other structurally sound protective material. The panel 16 is sized to fit within the opening defined by the frame 12 and tightly fit against vertical frame members 18, 20, as well as horizontal frame members 22 and 24.

The retaining bars 10 are positioned within the frame, tensioned between the vertical panel members 18 and 20, or may be tensioned between horizontal frame members 22, 24, if desired. Each of the retaining bars 10 is comprised of two elongated members, a first elongated tubular bar member 30 and a second elongated bar member 32 telescopically engageable within a tubular opening of the first bar member 30.

A first mounting bracket 34 is secured on a free end of the first bar member 30. A second mounting bracket assembly 36 is secured on the free end of the second bar member 32. The first bar member 30 is provided with a plurality of openings 40 formed through an outside wall 42 of the first bar member 30. Corresponding openings 44 are formed in the inside wall 46 of the first bar member 30. The openings 40 and 44 are aligned, allowing extension of a locking means therethrough.

The locking means of the present invention comprises one or more snap buttons 48 and 50, which are extendable through the openings 40,44 when released. The snap buttons 48 and 50 are secured on a tension member 52, which has a generally V-shaped configuration and carries the snap buttons 48 and 50 on respective legs 54 and 56. The tension member 52 normally urges the locking buttons 48, 50 into the openings 40,44. When depressed, the snap buttons 48 and 50 recede into a channel 60 defined by the second bar member 32 (FIG. 4), facilitating telescopical slidable movement of the second bar member 32 in relation to the first bar member 30. When released, the snap buttons 48 and 50 are forced into the aligned openings 44 and 40 respectively, thereby fixing the length of the retainer bar 10 to the desired length for the opening in the frame 12.

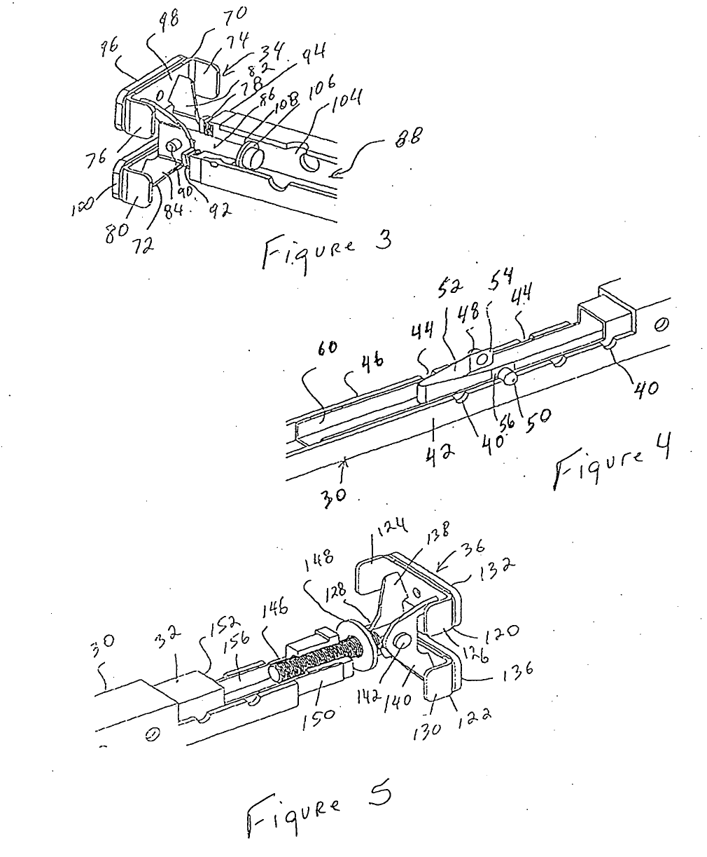

Turning now to FIG. 3, the first bracket assembly 34 is illustrated in more detail. As can be seen in the drawing, the bracket assembly 34 comprises a pair of U-shaped bracket members 70 and 72 spaced vertically in relation to each other. It is envisioned that the bracket assembly 34 may be provided with only one bracket member, if desired. The upper bracket member 70 has parallel taps 74 and 76, and the lower bracket member 72 has parallel taps 78 and 80. Bracket members 70 and 72 are retained in a spaced-apart relationship by a pair of spacer members 82 and 84.

The spacer members 82 and 84 are positioned on opposite sides of a securing rod 86, which is fitted within a channel 88 formed in the first retainer bar member 30. A securing pin 90 extends through the spacer member 84, the securing rod 86 and the spacer member 82. A washer 92 is positioned on a closed end 94 of the retainer bar member 30 and is frictionally fitted between the spacer members 82, 84 and the end piece 94. The washer 92 may be made from a compressible material, which “takes” up some of the rotational force and prevents over-tightening of the bar members 30, 32 when installed in the frame 12.

A protective pad 96 is fitted on an exterior surface of a central portion 98 of the upper bracket member 70. A similar protective pad 100 is fitted on the bracket member 84. The protective pads 96 and 100 are pressed against a frame member 18 so as not to cause damage to the frame itself. A tightening rod 102 (FIG. 1) is optionally provided for fitting into openings 104 formed in the bar member 30. The tightening rod 102 helps to better tighten the bar member 30 within the frame 12.

To prevent disengagement of the bracket assembly 34 from the retaining bar member 30, the rod 86 carries an enlarged diameter stop member, which frictionally engages the interior walls of the retainer bar member 30 and prevents disengagement of the rod 86 when contacting an open end 108 of the end piece 94. The first bar member 30 freely rotates in relation to the bracket assembly 34 and in relation to the second bar member 32.

Turning now to FIG. 5, an adjustable end of the second retainer bar member 32 is shown in more detail. As can be seen in the drawing, the bracket assembly 36 is provided with a pair of spaced-apart bracket members 120 and 122, although the bracket assembly 36 may have only one bracket member, if desired. Each bracket member 120 and 122 is formed as a U-shaped body, similar to the bracket members 70 and 72 of the assembly 34. Each bracket member 120 and 122 has a pair of parallel tabs 124, 126 and 128,130 respectively. The central portions of each bracket members 120, 122 are fitted with protective pads 132 and 136. A pair of spacers, or spacer members 138 and 140 retain the bracket members 120, 122 in spaced-apart relationship to each other. The spacer members 138, 140 are secured together with a securing pin 142.

A threaded rod 146 is fitted between the spacers 138 and 140, passing through the rod 146. The threaded rod 146 carries a stop member 148 which can be a circular washer fitted to threadably engage the exterior of the rod 146. An end piece 150 is fitted in the open end 152 of the second bar retainer member 32. A tubular channel 156 is formed in the end piece 150 to receive the rod 146 therein.

In operation, the user places the protective panel 16 over the glass 14 and mounts one or two retainer bars 10 within the vertical frame members 18 and 20. First, a fixed end with the bracket assembly 34 is placed against the inside of the frame member 18. One of the tabs presses against the protective panel 16, as shown in FIG. 2. The bar member 32 is extended outwardly from the first bar member 30 until the bracket assembly 36 contacts the inside of the vertical frame member 20. The rod 146 allows rotation of the bracket assembly 36 so that a tight fit is achieved.

Next, the adjustable snap buttons 48 and 50 are depressed to allow movement of the bar 32 in relation to the bar member 30 for a rough adjustment. The retainer bar member 30 is rotated, with the snap buttons 48 and 50 depressed to achieve the desired tight fit. The bracket assemblies 34 and 36 do not rotate at this time. The tightening rod 102 may be inserted into the openings 104 to further ensure a tight position of the bar 10 within the frame 12. The washer 92 prevents over tightening of the retainer bar 10.

Once the desired position is achieved, the snap buttons 48 and 50 can be released to snap into position and to further ensure a secure grip of the retaining bar against the interior of the frame members 18 and 20. If desired, the first bar member 30 can be rotated in relation to the panel in the directions of arrow 160 (FIG. 1) to tighten or loosen position of the retaining bar 10 in the frame. If necessary, an open-end wrench or a crescent wrench can be used to apply rotating force to the retaining bar member 30. Depending on the direction of rotation, the second bar member 32, moving along the threaded screw 146 can be extended or moved inside the first retaining bar member 30. The length of the bar members 30 and 32 is selected to be adjustable between a 3 foot window frame to a 4½ foot window frame or within larger windows or door openings.

The retainer bar 10 can be installed in a relatively short period of time following notification from the National Weather Service that a hurricane or tornado or other high windstorm is approaching. The protective panel 16 can be precut to fit into the desired openings and one or two retaining bars 10 positioned over the panel 16 to keep the panel 16 place within screws or nails. Once the danger has passed, the retainer bars 10 can be removed by loosening the position of the retainer bar member 30 and 32 in relation to each other, and the protective panel 16 removed and stored for future use if necessary.

The retainer bar 10 allows securing of the protective panel 16 within the building openings without any damage to the integral structure of the frames 12, thereby facilitating warranty protection offered by the manufacturer. The retaining bars 10 can be made from lightweight non-corrosive structurally strong material, such aluminum and the like.

Many changes and modifications can be made in the design of the present invention without departing from the spirit thereof. I therefore pray that my rights to the present invention be limited only by the scope of the appended claims.

I claim:

1. An apparatus for retaining protecting panels placed in a recess of a wall of a building fitted with a frame, comprising:
at least one adjustable retainer bar positioned between opposing frame members, said retainer bar comprising a first bar member having a first closed end portion and a second end portion, a second bar member telescopically slidably engaged with the second end of the first bar member, and a bracket assembly carried by a free end of each of said first bar member and the second bar member, said bracket assembly being configured for tensioning against a respective frame member.

2. The apparatus of claim 1, wherein said first bar member is configured for free rotation in relation to the second bar member.

3. The apparatus of claim 1, further comprising a means for adjusting extension of the second bar member from the open end of the first bar member.

4. The apparatus of claim 3, wherein said extension adjusting means comprises a locking member mounted inside the second bar member, said locking member comprising at least one depressible locking button secured to a compressible tension member, said depressible locking button being configured, when released, to extend through one of a plurality of locking button receiving openings formed in the first bar member.

5. The apparatus of claim 1, wherein a first bracket assembly is adjustably mounted on the free end of the first bar member, said first bar member being freely rotatable in relation to said first bracket member.

6. The apparatus of claim 5, wherein said first bracket assembly comprises at least one bracket member carrying a protective pad for contacting a corresponding frame member.

7. The apparatus of claim 5, wherein said first bracket assembly comprises a pair of spaced apart bracket members and a retaining rod fitted between the bracket members, said rod extending into the first bar member.

8. The apparatus of claim 5, wherein said first bracket assembly comprises a means for preventing over-tightening of position of the first bracket assembly in the frame.

9. The apparatus of claim 8, wherein said means for preventing over-tightening comprises a compressible washer mounted between the first bracket assembly and the first bar member.

10. The apparatus of claim 1, wherein a second bracket assembly is adjustably mounted on the free end of the second bar member.

11. The apparatus of claim 10, wherein said second bracket assembly comprises at least one bracket member carrying a protective pad for contacting a corresponding frame member.

12. The apparatus of claim 10, wherein said second bracket assembly comprises a pair of spaced apart bracket members and a threaded rod fitted between the bracket members, said rod extending into the second bar member to facilitate adjustable tightening of extension of the second bar member in relation to the first bar member.

13. The apparatus of claim 1, wherein said first bar member is provided with at least one opening adjacent the free end of the first bar member.

14. The apparatus of claim 13, further comprising a tightening rod configured for inserting into said at least one opening and applying torque to the first bar member.

15. An apparatus for retaining protecting panels placed in a recess of a wall of a building fitted with a frame, comprising:
at least one adjustable retainer bar positioned between opposing frame members, said retainer bar comprising a first bar member having a first closed end portion and a second end portion, a second bar member telescopically slidably engaged with the second end of the first bar member, and a first bracket assembly and a second bracket assembly pair of bracket assemblies carried by a respective free end of each of said first bar member and the second bar member, each of said bracket assemblies being configured for tensioning against a respective frame member, said first bar member is configured for free rotation in relation to the second bar member and a respective bracket assembly.

16. The apparatus of claim 15, wherein each of said first bracket assembly and said second bracket assembly comprises a pair of spaced-apart generally U-shaped bracket members and an elongated rod secured between the bracket members.

17. The apparatus of claim 16, wherein a rod secured between the bracket members of the second bracket assembly has external threads to facilitate tightening of engagement between the second bar member and a respective frame member.

18. The apparatus of claim 15, further comprising a means for adjusting extension of the second bar member from the open end of the first bar member, said adjusting means comprises a locking member mounted inside the second bar member, said locking member comprising at least one depressible locking button secured to a compressible tension member, said depressible locking button being configured, when released, to extend through one of a plurality of locking button receiving openings formed in the first bar member.

19. The apparatus of claim 15, wherein said first bracket assembly comprises a means for preventing over-tightening of position of the first bracket assembly in the frame, said means for preventing over-tightening comprising a compressible washer mounted between the first bracket assembly and the first bar member.
